(19) United States
(12) Patent Application Publication
(10) Pub. No.: US 2013/0257860 A1
(43) Pub. Date: Oct. 3, 2013

(54) SYSTEM AND METHOD FOR PROCESSING MEDICAL IMAGES AND COMPUTER-READABLE MEDIUM

(71) Applicants: KABUSHIKI KAISHA TOSHIBA, Tokyo (JP); TOSHIBA MEDICAL SYSTEMS CORPORATION, Otawara-shi (JP)

(72) Inventors: Maiko TEZUKA, Nasushiobara-shi (JP); Iwao GOTO, Nasushiobara-shi (JP); Yosuke OKUBO, Nasushiobara-shi (JP); Masato SHIBUYA, Otawara-shi (JP); Koichi TERAI, Otawara-shi (JP)

(73) Assignees: Toshiba Medical Systems Corporation, Otawara-shi (JP); Kabushiki Kaisha Toshiba, Tokyo (JP)

(21) Appl. No.: 13/854,327

(22) Filed: Apr. 1, 2013

(30) Foreign Application Priority Data
Apr. 2, 2012 (JP) 2012-084337
Mar. 12, 2013 (JP) 2013-049187

(51) Int. Cl. G06T 15/00

(52) U.S. Cl. CPC G06T 15/00
USPC 345/419

(57) ABSTRACT

A medical image processing system according to an embodiment includes a display unit, a generating unit, and a controlling unit. The display unit displays a medical image. The generating unit generates a display image used for stereoscopically displaying either text data or image data representing content of an item contained in either additional information or examination information of the medical image. The controlling unit causes the display image to be displayed on the display unit.

### CROSS-REFERENCE TO RELATED APPLICATIONS

This application is based upon and claims the benefit of priority from Japanese Patent Application No. 2012-084337, filed on Apr. 2, 2012; and Japanese Patent Application No. 2013-049187, filed on Mar. 12, 2013, the entire contents of all of both of which are incorporated herein by reference.

### FIELD

Embodiments described herein relate generally to a system and a method for processing medical images and a computer-readable medium.

### BACKGROUND

A medical image processing system that has conventionally been known includes one or more medical image taking apparatuses, a medical image storing apparatus, and a medical image display apparatus. Generally speaking, such a medical image processing system is configured to manage medical images taken by the one or more medical image taking apparatuses and to manage information that is referred to during an image interpretation process or a medical examination process (hereinafter, simply “examination process”), as additional information or medical examination information (hereinafter, simply “examination information”) of the medical images.

### BRIEF DESCRIPTION OF THE DRAWINGS

FIG. 1 is a diagram of an exemplary configuration of a medical image processing system according to an embodiment;

FIG. 2 is a functional block diagram of an exemplary configuration of a medical image storing apparatus according to the present embodiment;

FIG. 3 is a drawing of an example of a display unit according to the present embodiment;

FIGS. 4 and 5 are drawings of other examples of the display unit according to the present embodiment;

FIG. 6 is a table illustrating examples of pieces of information stored in an importance level storage unit according to the present embodiment;

FIG. 7 is a drawing of examples of pieces of volume data stored in a three-dimensional data storage unit according to the present embodiment;

FIG. 8 is a drawing of examples of pieces of volume data generated by a disparity image generating unit according to the present embodiment;

FIG. 9 is a drawing of examples of volume rendering processes performed by the disparity image generating unit according to the present embodiment;

FIG. 10 is a drawing of an example of an image viewer displayed by a display controlling unit according to the present embodiment;

FIGS. 11 and 12 are examples of pieces of image data of groups of disparity images displayed in an image viewer by the display controlling unit according to the present embodiment;

FIG. 13 is a drawing of an example of an examination list displayed by the display controlling unit according to the present embodiment;

FIG. 14 is a drawing of an example of image data of a group of disparity images displayed over the examination list by the display controlling unit according to the present embodiment; and

FIGS. 15 to 17 are flowcharts of procedures in image processing processes performed by the medical image storing apparatus according to the present embodiment.

### DETAILED DESCRIPTION

A medical image processing system according to an embodiment includes a display unit, a generating unit, and a controlling unit. The display unit displays a medical image. The generating unit generates a display image used for stereoscopically displaying either text data or image data representing content of an item contained in either additional information or examination information of the medical image. The controlling unit causes the display image to be displayed on the display unit.

Exemplary embodiments of a medical image processing system and a computer-readable medium disclosed herein will be explained in details below, with reference to the accompanying drawings. First, some of the terms used in the description of the exemplary embodiments below will be explained. The term “a group of disparity images” refers to a group of images obtained by shifting a viewpoint position where an object is viewed from, by a predetermined disparity angle at a time. For example, it is possible to generate “a group of disparity images” by performing a volume rendering process on volume data while shifting the viewpoint position by a predetermined disparity angle at a time. In another example, it is possible to generate “a group of disparity images” by performing a calculating process so as to arrange a predetermined shape (e.g., a parallelepiped) to be viewed stereoscopically. In other words, the “group of disparity images” is made up of a plurality of “disparity images” having mutually-different “viewpoint positions”. The term “disparity angle” refers to an angle determined by two viewpoint positions positioned adjacent to each other among viewpoint positions that have been set for generating “a group of disparity images” and a predetermined position in a space (e.g., the center of the space) expressed by the volume data. The term “disparity number” refers to the number of “disparity images” required to realize a stereoscopic view on a monitor capable of providing a stereoscopic view. Further, the term “nine-eye disparity images” used herein refers to “a group of disparity images” made up of nine “disparity images”. The term “two-eye disparity images” used herein refers to “a group of disparity images” made up of two “disparity images”.

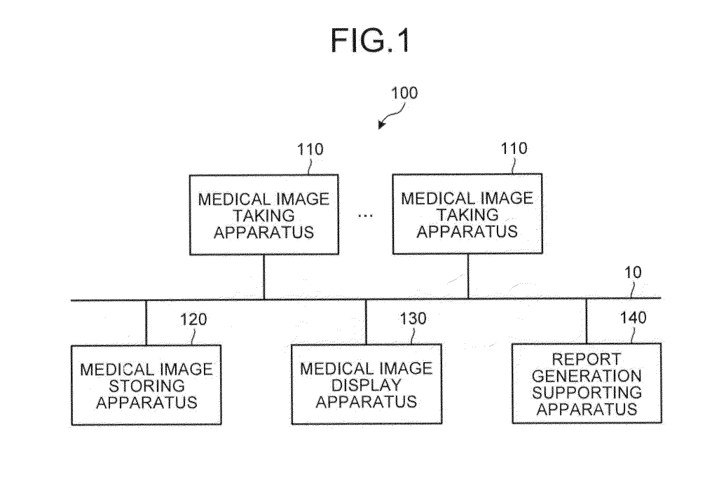

First, a medical image processing system according to the present embodiment will be explained. FIG. 1 is a drawing of an exemplary configuration of the medical image processing system according to the present embodiment. As shown in FIG. 1, a medical image processing system 100 according to the present embodiment includes medical image taking apparatuses 110, a medical image storing apparatus 120, a medical image display apparatus 130, and a report generation supporting apparatus 140. The apparatuses illustrated in FIG. 1 are able to communicate with one another directly or indirectly via, for example, an intra-hospital Local Area Network (LAN) 10 set up in a hospital. For example, if a Picture Archiving and Communication System (PACS) has been introduced into the medical image processing system 100, the apparatuses send and receive medical images and the like to and from one another according to the Digital Imaging and Communications in Medicine (DICOM) standard.

The medical image taking apparatuses 110 may include any of the following: an X-ray diagnosis apparatus, an X-ray Computed Tomography (CT) apparatus, a Magnetic Resonance Imaging (MRI) apparatus, an ultrasound diagnosis apparatus, a Single Photon Emission Computed Tomography (SPECT) apparatus, a Positron Emission computed Tomography (PET) apparatus, a SPECT-CT apparatus having a SPECT apparatus and an X-ray CT apparatus incorporated therein, a PET-CT apparatus having a PET apparatus and an X-ray CT apparatus incorporated therein, and a group of apparatuses made up of any of these apparatuses.

More specifically, each of the medical image taking apparatuses 110 generates image data of one or more medical images (hereinafter, simply “medical images”) by taking images of an examined subject (hereinafter, “patient”). For example, each of the medical image taking apparatuses 110 acquires data such as projection data or Magnetic Resonance (MR) signals by taking images of the patient and generates the image data of the medical images by reconstructing the acquired data. Further, each of the medical image taking apparatuses 110 sends the generated image data to the medical image storing apparatus 120. When sending the image data to the medical image storing apparatus 120, each of the medical image taking apparatuses 110 sends, together with the image data, additional information containing, for example, a patient ID identifying the patient, an examination ID, the patient's name, the age and the gender of the patient, the quantity of images indicating the quantity of medical images taken.

Further, each of the medical image taking apparatuses 110 receives an input of examination information from a technician or the like who took the medical images. Further, together with the image data of the medical images serving as an examination target, each of the medical image taking apparatuses 110 sends the received examination information to the medical image storing apparatus 120. The examination information in this situation is information used by the technician or the like to request an image interpretation doctor to interpret the medical images taken by using the medical image taking apparatus 110. The examination information contains items such as an importance level of the examination, the type of examination, and the type of the taken medical images.

The medical image storing apparatus 120 is an apparatus configured to store therein the medical images and the examination information. More specifically, when having received the image data of the medical images and the additional information from any of the medical image taking apparatuses 110, the medical image storing apparatus 120 stores, into a storage unit, the received image data and the received additional information that are kept in correspondence with each other. Also, when having received the examination information and the image data from any of the medical image taking apparatuses 110, the medical image storing apparatus 120 stores, into a storage unit, the received examination information and the received image data that are kept in correspondence with each other.

Further, the medical image storing apparatus 120 has a function of displaying an image viewing tool (hereinafter, the “image viewer”) used for displaying medical images in response to a request from an operator. The image viewer is used when the image interpretation doctor interprets the medical images. Further, the medical image storing apparatus 120 has a function of displaying an examination list used for conducting a search in the examination information in response to a request from the operator. The examination list is used by a requesting doctor who was requested to perform the examination, the technician, or the image interpretation doctor, for checking the examination information.

The medical image display apparatus 130 is an apparatus configured to display the image data of the medical images. More specifically, in response to a request from the operator, the medical image display apparatus 130 obtains the image data from the medical image storing apparatus 120 and displays the obtained image data on a display unit.

The report generation supporting apparatus 140 is an apparatus configured to support an interpretation report generating process performed by the image interpretation doctor, or the like. More specifically, the report generation supporting apparatus 140 receives an input of information such as an opinion about the examination from the operator and stores therein the received information as report information. Further, in response to a request from the operator, the report generation supporting apparatus 140 obtains the image data from the medical image storing apparatus 120 and stores therein the obtained image data in correspondence with the report information.

The exemplary configuration of the medical image processing system 100 according to the present embodiment has thus been explained briefly. The application of the medical image processing system 100 described above is not limited to the situation where the PACS is introduced. For example, it is possible to apply the medical image processing system 100 similarly to a situation where an electronic medical record system that manages electronic medical records to which medical images are attached is introduced. In that situation, the medical image storing apparatus 120 is configured as a database storing therein the electronic medical records. Further, it is acceptable to apply the medical image processing system 100 similarly to a situation where, for example, a Hospital Information System (HIS), or a Radiology Information System (RIS) is introduced. Further, the medical image processing system 100 is not limited to the exemplary configuration described above. The functions of the apparatuses and the distribution of the functions among the apparatuses may be changed as necessary according to modes of operation thereof.

Conventionally, for example, when interpreting medical images and checking examination information by using medical image storing apparatuses, image interpretation doctors may refer to the additional information related to the medical images serving as a target of the image interpretation, while interpreting the medical images using an image viewer. For example, image interpretation doctors may check the patient ID, the patient's name, the quantity of images, and the like. Also, when checking examination information by using an examination list, requesting doctors, technicians, and image interpretation doctors may conduct a search in the examination information by specifying one of the items contained in the examination information. For example, requesting doctors, technicians, and image interpretation doctors may check the examination information while prioritizing pieces of examination information having higher levels of urgency, by conducting a search in the examination information while referring to levels of urgency each of which indicates the urgency of the examination.

However, when images are interpreted by using an image viewer, there is a possibility that conventional medical image storing apparatuses may overlook information of some important items contained in the additional information. Also, when an examination is performed by using an examination list, there is a possibility that conventional medical image storing apparatuses may overlook information of some items required in the search contained in the examination information.

To cope with these situations, when the image viewer or the examination list is used, the medical image storing apparatus 120 according to the present embodiment is configured so as to cause a stereoscopic display monitor capable of displaying a stereoscopic image to display either text data or image data representing the contents of one of items contained in either the additional information or the examination information of the medical images, in such a manner that a stereoscopic view thereof is provided. With this arrangement, when the medical images are interpreted or when the examination information is checked, the contents of the item in either the additional information or the examination information are displayed while being emphasized, it is possible to prevent these types of information from being overlooked.

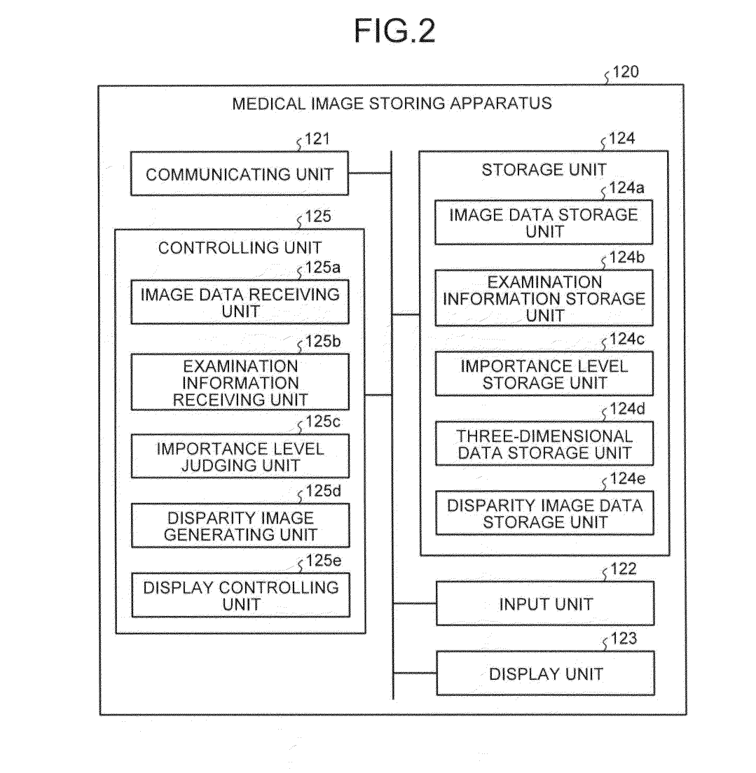

Next, the medical image storing apparatus 120 configured as described above will be explained in details. FIG. 2 is a functional block of an exemplary configuration of the medical image storing apparatus 120 according to the present embodiment. As shown in FIG. 2, the medical image storing apparatus 120 includes a communicating unit 121, an input unit 122, a display unit 123, a storage unit 124, and a controlling unit 125.

The communicating unit 121 is configured to communicate various types of information with other apparatuses. The communicating unit 121 is configured by using a Network Interface Card (NIC), for example. Further, the communicating unit 121 is configured to, for example, receive the image data of the medical images and the additional information from any of the medical image taking apparatuses 110 and to forward the received image data to an image data receiving unit 125a (explained later), together with the additional information. Also, the communicating unit 121 is configured to receive the examination information and the image data from any of the medical image taking apparatuses 110 and to forward the received examination information to an examination information receiving unit 125b (explained later), together with the image data.

The input unit 122 is configured to receive inputs of various types of operations performed on the medical image storing apparatus 120 from the operator. For example, the input unit 122 is configured with a mouse, a keyboard, a trackball and/or the like. Further, for example, the input unit 122 is configured to receive a request for displaying the image viewer or a request for displaying the examination list from the operator.

The display unit 123 is a monitor configured to display the medical images. According to the present embodiment, the display unit 123 is a stereoscopic display monitor capable of displaying a stereoscopic image by displaying a group of disparity images. For example, the display unit 123 is a stereoscopic display monitor that enables a glass-free viewing person to have a stereoscopic view of multiple-eye disparity images such as nine-eye disparity images by using a light beam controller such as a lenticular lens. Such a stereoscopic display monitor is configured to enable the viewing person to have a stereoscopic view using a binocular disparity and further enables the viewing person to have a stereoscopic view using a motion disparity, by which the viewed pictures also change in accordance with shifting of the viewpoints of the viewing person.

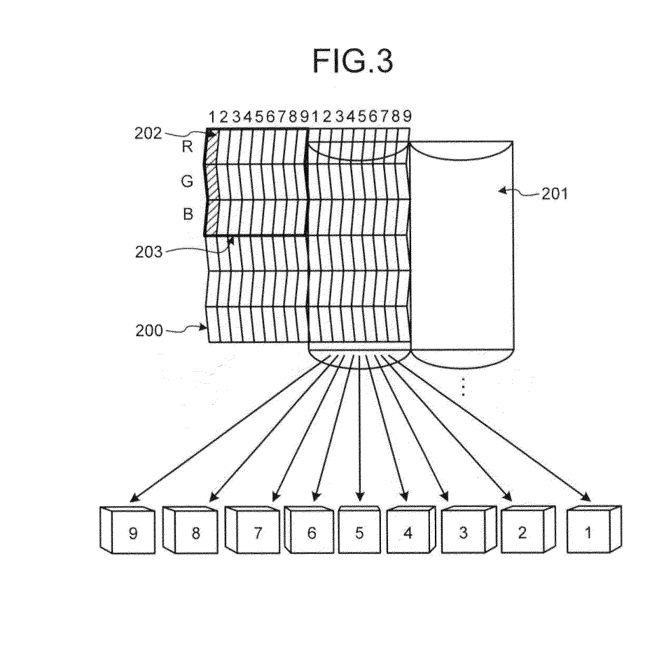

FIG. 3 is a drawing of an example of the display unit 123 according to the present embodiment. As shown in FIG. 3, a stereoscopic display monitor that realizes a stereoscopic display by using nine-eye disparity images is configured so that a light beam controller is disposed to the front of a flat-shaped display surface 200 such as a liquid crystal panel. For example, the stereoscopic display monitor shown in FIG. 3 is configured so that, as the light beam controller, a vertical lenticular sheet 201 of which the optical openings extend in vertical directions is pasted onto the front of the display surface 200. In the example shown in FIG. 3, the vertical lenticular sheet 201 is pasted in such a manner that the convex parts thereof are positioned to the front. However, the vertical lenticular sheet 201 may be pasted in such a manner that the convex parts thereof face the display surface 200.

As shown in FIG. 3, on the display surface 200, pixels 202 are arranged in a matrix formation, each of the pixels 202 having a length-width ratio of 3:1 and having three sub-pixels for red (R), green (G), and blue (B) arranged in the lengthwise direction. The stereoscopic display monitor shown in FIG. 3 is configured to convert nine-eye disparity images made up of nine images into intermediate images that are arranged in a predetermined format (e.g., in a lattice pattern) and outputs the conversion result to the display surface 200. In other words, the stereoscopic display monitor shown in FIG. 3 outputs nine pixels in mutually the same position in the nine-eye disparity images, while assigning those pixels to nine columns of the pixels 202, respectively. The nine columns of pixels 202 form a unit pixel group 203 that simultaneously displays nine images having mutually-different viewpoint positions.

The nine-eye disparity images that are simultaneously output as the unit pixel group 203 from the display surface 200 are emitted as parallel beams by, for example, a Light Emitting Diode (LED) backlight and are further emitted in multiple directions by the vertical lenticular sheet 201. Because the light beams of the pixels in the nine-eye disparity images are emitted in the multiple directions, the light beams entering the right eye and the left eye of the viewing person change in conjunction with the position of the viewing person (the viewpoint position). In other words, depending on the angle at which the viewing person views the image, the disparity angles of the disparity image entering the right eye and the disparity image entering the left eye vary. As a result, the viewing person is able to have a stereoscopic view of the target of an image-taking process (hereinafter, “image-taking target”) at each of the nine positions shown in FIG. 3, for example.

Further, for example, the viewing person is able to have a stereoscopic view at the position “5” shown in FIG. 3 while facing the image-taking target straight on and is able to have a stereoscopic view at each of the positions other than the position “5” shown in FIG. 3 while the direction of the image-taking target is varied. The stereoscopic display monitor shown in FIG. 3 is merely an example. The stereoscopic display monitor that displays nine-eye disparity images may be configured with liquid crystal stripes arranged in a widthwise direction such as “R, R, R, . . . G, G, G, . . . B, B, B, . . . ” as shown in FIG. 3 or may be configured with liquid crystal stripes arranged in a lengthwise direction such as “R, G, B, R, G, B, . . . ”. Further, the stereoscopic display monitor shown in FIG. 3 may be realized with a lengthwise lens method where the lenticular sheet is positioned vertically as shown in FIG. 3 or may be realized with a diagonal lens method where the lenticular sheet is positioned diagonally.

As another example of the stereoscopic display monitor, a stereoscopic display monitor may provide a stereoscopic view of two-eye disparity images (may be referred to as “binocular disparity images”) with the use of an exclusive-use device such as stereoscopic glasses. It is also possible to use such a stereoscopic display monitor as the display unit 123.

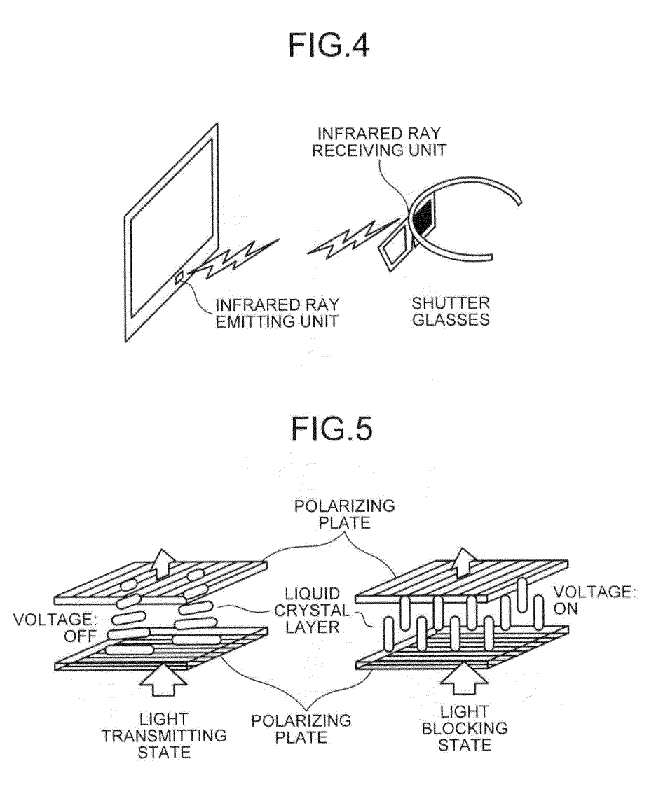

FIGS. 4 and 5 are drawings of another example of the display unit 123 according to the present embodiment. The example shown in FIGS. 4 and 5 illustrates a stereoscopic display monitor that realizes a stereoscopic display by using a shutter method and uses shutter glasses as the stereoscopic glasses worn by the viewing person who looks at the monitor. The stereoscopic display monitor is configured to alternately emit two-eye disparity images from the monitor. For example, the monitor shown in FIG. 4 emits images to be viewed by the left eye (hereinafter, “left-eye images”) and images to be viewed by the right eye (hereinafter, “right-eye images”) alternately at 120 Hz. In this situation, as shown in FIG. 4, the monitor is provided with an infrared ray emitting unit, which controls emissions of infrared rays in synchronization with the timing with which the images are switched.

The infrared rays emitted from the infrared ray emitting unit are received by an infrared ray receiving unit of the shutter glasses shown in FIG. 4. Each of the left and right frames of the shutter glasses has a shutter attached thereto, so that the shutter glasses are able to alternately switch between a light transmitting state and a light blocking state, for each of the left and the right shutters in synchronization with the timing with which the infrared rays are received by the infrared ray receiving unit. In the following sections, the process to switch between the light transmitting state and the light blocking state of the shutters will be explained.

As shown in FIG. 5, each of the shutters includes an entering-side polarizing plate and an exiting-side polarizing plate and further includes a liquid crystal layer between the entering-side polarizing plate and the exiting-side polarizing plate. The entering-side polarizing plate and the exiting-side polarizing plate are positioned orthogonal to each other as shown in FIG. 5. In this situation, as shown in FIG. 5, while the voltage is not applied (“OFF”), the light that has passed through the entering-side polarizing plate is rotated by 90 degrees due to an action of the liquid crystal layer and transmits through the exiting-side polarizing plate. In other words, the shutter is in the light transmitting state while the voltage is not being applied. On the contrary, as shown in FIG. 5, while the voltage is being applied (“ON”), because the polarization rotation action of the liquid crystal molecules in the liquid crystal layer is lost, the light that has passed through the entering-side polarizing plate is blocked by the exiting-side polarizing plate. In other words, the shutter is in the light blocking state while the voltage is being applied.

In this arrangement, for example, the infrared ray emitting unit emits infrared rays during the time period when a left-eye image is being displayed on the monitor. The infrared ray receiving unit applies no voltage to the left-eye shutter and applies a voltage to the right-eye shutter, during the time period when receiving the infrared rays. As a result, as shown in FIG. 4, the right-eye shutter is in the light blocking state, whereas the left-eye shutter is in the light transmitting state, so that the left-eye image goes into the left eye of the viewing person. On the contrary, the infrared ray emitting unit stops emitting infrared rays during the time period when a right-eye image is being displayed on the monitor. The infrared ray receiving unit applies no voltage to the right-eye shutter and applies a voltage to the left-eye shutter, during the time period when receiving no infrared rays. As a result, the left-eye shutter is in the light blocking state, whereas the right-eye shutter is in the light transmitting state, so that the right-eye image goes into the right eye of the viewing person.

In this manner, the stereoscopic display monitor shown in FIGS. 4 and 5 displays the images capable of providing the viewing person with a stereoscopic view, by switching the images displayed by the monitor and the state of the shutters in conjunction with one another. Instead of the shutter method described above, a monitor that uses a polarized-glasses method is also known as a stereoscopic display monitor that is capable of providing a stereoscopic view of two-eye disparity images.

Returning to the description of FIG. 2, the storage unit 124 is a storage device configured to store therein various types of information. For example, the storage unit 124 is configured with a hard disk, a semiconductor memory, or the like. Further, for example, the storage unit 124 includes an image data storage unit 124a, an examination information storage unit 124b, an importance level storage unit 124c, a three-dimensional data storage unit 124d, and a disparity image data storage unit 124e.

The image data storage unit 124a stores therein the image data of the medical images and the additional information received by the image data receiving unit 125a (explained later). More specifically, the image data storage unit 124a stores therein the image data of the medical images and the additional information sent from any of the medical image taking apparatuses 110, while keeping the image data and the additional information in correspondence with each other.

The examination information storage unit 124b stores therein the examination information received by the examination information receiving unit 125b (explained later). More specifically, the examination information storage unit 124b stores therein the examination information and the image data sent from any of the medical image taking apparatuses 110, while keeping the examination information and the image data in correspondence with each other.

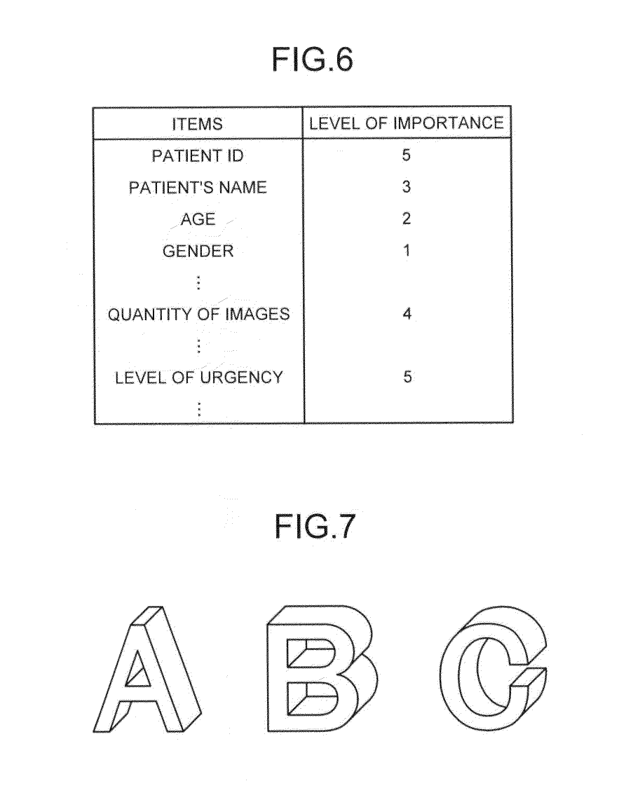

The importance level storage unit 124c stores therein a level of importance for each of items contained in either the additional information or the examination information of the medical images. For each of the items used for interpreting the medical images and each of the items used for conducting a search in the examination information, the importance level storage unit 124c stores therein a level of importance. FIG. 6 is a table illustrating examples of pieces of information stored in the importance level storage unit 124c according to the present embodiment. As shown in FIG. 6, for example, the importance level storage unit 124c stores therein each of the items contained in either the additional information or the examination information of the medical images in correspondence with a level of importance. In this situation, examples of the items contained in the additional information of the medical images include “patient ID”, “patient's name”, “age”, “gender”, and “quantity of images”. Examples of the items contained in the examination information include “level of urgency” indicating the urgency of the examination. The levels of importance are expressed by, for example, numerical values of “1” to “5” in such a manner that a larger numerical value is given to a higher level of importance.

The information stored in the importance level storage unit 124c is, for example, registered by a system administrator or the like when the medical image storing apparatus 120 is installed in a hospital or the like. At that time, a predetermined initial value is set as the level of urgency. After that, the information stored in the importance level storage unit 124c is updated, as appropriate, by an operator such as a technician or a medical doctor, for example. In other words, by updating the information stored in the importance level storage unit 124c, it is possible to set the levels of importance that vary for each of the practice fields such as hospitals.

The three-dimensional data storage unit 124d stores therein volume data that stereoscopically expresses various types of text data. The “various types of text data” in this situation include data of various types of texts such as Japanese characters, alphabets, numerals, and symbols. For example, for each of character codes used by the medical image storing apparatus 120, the three-dimensional data storage unit 124d stores therein volume data of the text data expressed by the character code.

FIG. 7 is a drawing of examples of pieces of volume data stored in the three-dimensional data storage unit 124d according to the present embodiment. For example, as shown in FIG. 7, the three-dimensional data storage unit 124d stores therein volume data that stereoscopically expresses text data in a three-dimensional space. The example in FIG. 7 illustrates volume data stereoscopically expressing alphabets “A”, “B”, and “C”. The volume data stored in the three-dimensional data storage unit 124d is defined by, for example, three-dimensional coordinates and voxel values.

The disparity image data storage unit 124e stores therein image data of disparity images generated by a disparity image generating unit 125d (explained later). More specifically, the disparity image data storage unit 124e stores therein a group of disparity images used for displaying either the text data or the image data representing the contents of one of the items contained in either the additional information or the examination information of the medical images, in such a manner that a stereoscopic view thereof is provided. As a result of the display unit 123 being caused to display the image data of the disparity images stored in the disparity image data storage unit 124e, either the text data or the image data representing the contents of the item contained in either the additional information or the examination information of the medical images is displayed in such a manner that a stereoscopic view thereof is provided.

The disparity image data storage unit 124e stores therein the image data of the group of disparity images in correspondence with either the image data or the examination information of the medical images. For example, when an image ID that uniquely identifies the image data or an examination ID that uniquely identifies the examination information is being used, the disparity image data storage unit 124e stores therein the image data of the group of disparity images in correspondence with either the image ID or the examination ID.

The controlling unit 125 is a processing apparatus that exercises overall control of the medical image storing apparatus 120. For example, the controlling unit 125 is configured by using an electronic circuit such as a Central Processing Unit (CPU) or a Micro Processing Unit (MPU), or an integrated circuit such as an Application Specific Integrated Circuit (ASIC) or a Field Programmable Gate Array (FPGA). In the present embodiment, the controlling unit 125 includes the image data receiving unit 125a, the examination information receiving unit 125b, an importance level judging unit 125c, the disparity image generating unit 125d, and a display controlling unit 125e.

The image data receiving unit 125a is configured to receive the image data of the medical images sent from any of the medical image taking apparatuses 110. More specifically, when having received the image data and the additional information sent from any of the medical image taking apparatuses 110 via the communicating unit 121, the image data receiving unit 125a stores the received image data into the image data storage unit 124a in correspondence with the received additional information. Also, when having received the image data and the additional information, the image data receiving unit 125a notifies the importance level judging unit 125c that the image data has been received. At that time, for example, the image data receiving unit 125a notifies the importance level judging unit 125c of an image ID identifying the received image data.

The examination information receiving unit 125b is configured to receive the examination information sent from any of the medical image taking apparatuses 110. More specifically, when having received the examination information and the image data sent from any of the medical image taking apparatuses 110 via the communicating unit 121, the examination information receiving unit 125b stores the received examination information into the examination information storage unit 124b in correspondence with the image data. Also, when having received the examination information and the image data, the examination information receiving unit 125b notifies the importance level judging unit 125c that the examination information has been received. At that time, for example, the examination information receiving unit 125b notifies the importance level judging unit 125c of an examination ID identifying the received examination information. In another example, it is acceptable to configure the examination information receiving unit 125b in such a manner that, when having received the examination information and the image data, the examination information receiving unit 125b stores the examination information into the examination information storage unit 124b and the image data into the image data storage unit 124a.

The importance level judging unit 125c is configured to specify, based on the levels of importance stored in the importance level storage unit 124c, an item for which a group of disparity images is to be generated, from among the items contained in either the additional information or the examination information of the medical images. More specifically, when being notified by the image data receiving unit 125a that image data has been received, the importance level judging unit 125c refers to the image data storage unit 124a and reads the additional information corresponding to the received image data. Also, when being notified by the examination information receiving unit 125b that image data has been received, the importance level judging unit 125c refers to the examination information storage unit 124b and reads the received examination information.

For example, when being notified by the image data receiving unit 125a of an image ID identifying image data, the importance level judging unit 125c refers to the image data storage unit 124a and reads the additional information of the image data corresponding to the notified image ID. Also, when being notified by the examination information receiving unit 125b of an examination ID identifying examination information, the importance level judging unit 125c refers to the examination information storage unit 124b and reads the examination information corresponding to the notified examination ID.

Further, on the basis of the levels of importance stored in the importance level storage unit 124c, the importance level judging unit 125c identifies the item for which the group of disparity images is to be generated, from among the items contained in either the read additional information or the read examination information. In the present embodiment, the importance level judging unit 125c specifies the item having the highest level of importance among the items contained in either the read additional information or the read examination information, as the item for which the group of disparity images is to be generated.

After that, the importance level judging unit 125c notifies the disparity image generating unit 125d of the identified item for which the group of disparity images is to be generated and the contents thereof. In this situation, for example, the importance level judging unit 125c notifies the disparity image generating unit 125d of either the image ID notified by the image data receiving unit 125a or the examination ID notified by the examination information receiving unit 125b, together with the identified item and the contents thereof.

The disparity image generating unit 125d is configured to generate the group of disparity images used for displaying either the text data or the image data representing the contents of the one of the items contained in the additional information or the examination information of the medical images, in such a manner that a stereoscopic view thereof is provided. More specifically, the disparity image generating unit 125d generates the group of disparity images for the item identified by the importance level judging unit 125c.

Even more specifically, when being notified by the importance level judging unit 125c of the identified item for which the group of disparity images is to be generated and the contents thereof, the disparity image generating unit 125d judges whether the notified item is the quantity of images. If the notified item is not the quantity of images, the disparity image generating unit 125d refers to the three-dimensional data storage unit 124d and reads the volume data corresponding to the text data representing the contents of the item. In this situation, if the text data representing the contents of the notified item is structured with a plurality of characters, the disparity image generating unit 125d reads a piece of volume data corresponding to each of the characters.

Further, by joining the read pieces of volume data together, the disparity image generating unit 125d generates volume data used for stereoscopically expressing the text data notified by the importance level judging unit 125c. For example, if the contents of the text data notified by the importance level judging unit 125c is “ABC”, the disparity image generating unit 125d reads pieces of volume data corresponding to “A”, “B”, and “C” from the three-dimensional data storage unit 124d. After that, by joining the three read pieces of volume data together, the disparity image generating unit 125d generates volume data that stereoscopically expresses “ABC”.

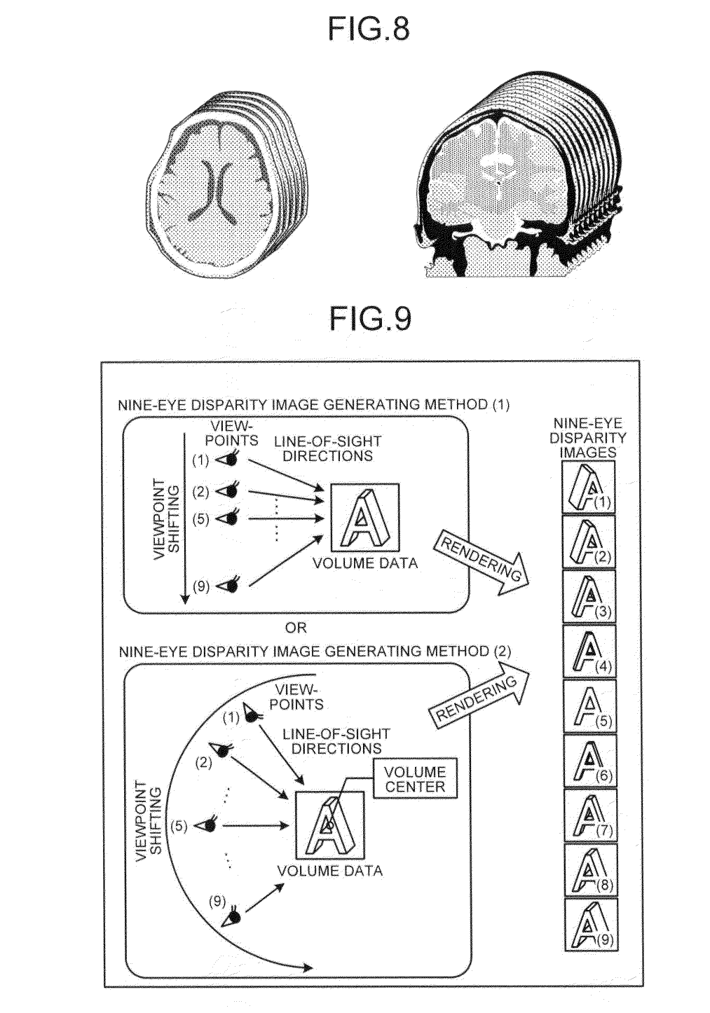

On the contrary, if the item notified by the importance level judging unit 125c is the quantity of images, the disparity image generating unit 125d generates a group of disparity images used for displaying the image data of which the thickness is varied according to the value of the quantity of images, in such a manner that a stereoscopic view thereof is provided. FIG. 8 is a drawing of examples of pieces of volume data generated by the disparity image generating unit 125d according to the present embodiment. As shown in FIG. 8, for example, the disparity image generating unit 125d generates volume data showing that the medical images corresponding to the quantity of medical images are overlapping one another so as to have a predetermined thickness. For example, the volume data on the left-hand side of FIG. 8 illustrates an example when the quantity of medical images is four, whereas the volume data on the right-hand side of FIG. 8 illustrates an example when the quantity of medical images is six. With the volume data configured in this manner, the larger the quantity of medical images is, the thicker is the viewed thickness, as a whole, of the plurality of medical images overlapping one another.

After having generated the volume data of either the text data or the image data in the manner described above, the disparity image generating unit 125d generates the group of disparity images of either the text data or the image data, by performing a volume rendering process on the generated volume data. FIG. 9 is a drawing of examples of volume rendering processes performed by the disparity image generating unit 125d according to the present embodiment. Examples will be explained below in which the disparity image generating unit 125d generates a group of disparity images made up of nine-eye disparity images while using a disparity angle of 1 degree; however, the degree of the disparity angle and the quantity of disparity images are not limited to these examples.

For example, as shown in “nine-eye disparity image generating method (1)” in FIG. 9, the disparity image generating unit 125d uses a parallel projection method and generates nine disparity images in which the disparity angles (the angles between the line-of-sight directions) are different by 1 degree each, by moving the viewpoint position to positions (1) to (9) in the manner of a parallel displacement, so that the disparity angles are mutually different by “1 degree”. When implementing the parallel projection method, the disparity image generating unit 125d sets a light source that radiates parallel light beams from an infinite distance along the line-of-sight directions.

As another example, as shown in “nine-eye disparity image generating method (2)” in FIG. 9, the disparity image generating unit 125d uses a perspective projection method and generates nine disparity images in which the disparity angles are different by 1 degree each, by moving the viewpoint position to positions (1) to (9) in the manner of a rotational shift, so that the disparity angles are mutually different by “1 degree” while being centered on the center (the gravity point) of the volume data. When implementing the perspective projection method, the disparity image generating unit 125d sets, at each of the viewpoints, a point light source or an area light source that three-dimensionally and radially radiates light being centered on the line-of-sight direction. Alternatively, when the perspective projection method is implemented, it is acceptable to move viewpoints (1) to (9) in the manner of a parallel displacement, depending on rendering conditions being used.

As yet another example, the disparity image generating unit 125d may perform a volume rendering process while using the parallel projection method and the perspective projection method together, by setting a light source that two-dimensionally and radially radiates light being centered on the line-of-sight direction with respect to the lengthwise direction of the volume rendering image to be displayed and that radiates parallel light beams from an infinite distance along the line-of-sight direction with respect to the widthwise direction of the volume rendering image to be displayed. The nine disparity images generated in this manner serve as the group of disparity images.

Further, when having generated the group of disparity images by performing the volume rendering process, the disparity image generating unit 125d stores image data of the generated group of disparity images into the disparity image data storage unit 124e. At this time, the disparity image generating unit 125d stores the generated group of disparity images into the disparity image data storage unit 124e, in correspondence with either the image data or the examination information of the medical images. For example, the disparity image generating unit 125d stores the image data of the group of disparity images in correspondence with either the image ID or the examination ID notified by the importance level judging unit 125c together with the specified item for which the group of disparity images is to be generated and the contents thereof.

Returning to the description of FIG. 2, the display controlling unit 125e is configured to cause the group of disparity images generated by the disparity image generating unit 125d to be displayed on the display unit 123. In this situation, while the image viewer used for displaying the medical images in response to a request from the operator is being displayed on the display unit 123, the display controlling unit 125e causes the group of disparity images to be displayed in the image viewer. As a result, either the text data or the image data representing the contents of the item contained in the additional information of the medical images is displayed in the image viewer, in such a manner that a stereoscopic view thereof is provided. In another example, while the examination list used for conducting a search in the examination information in response to a request from the operator is being displayed on the display unit 123, the display controlling unit 125e causes the group of disparity images to be displayed over the examination list. As a result, the text data representing the contents of the item contained in the examination information is displayed over the examination list, in such a manner that a stereoscopic view thereof is provided.

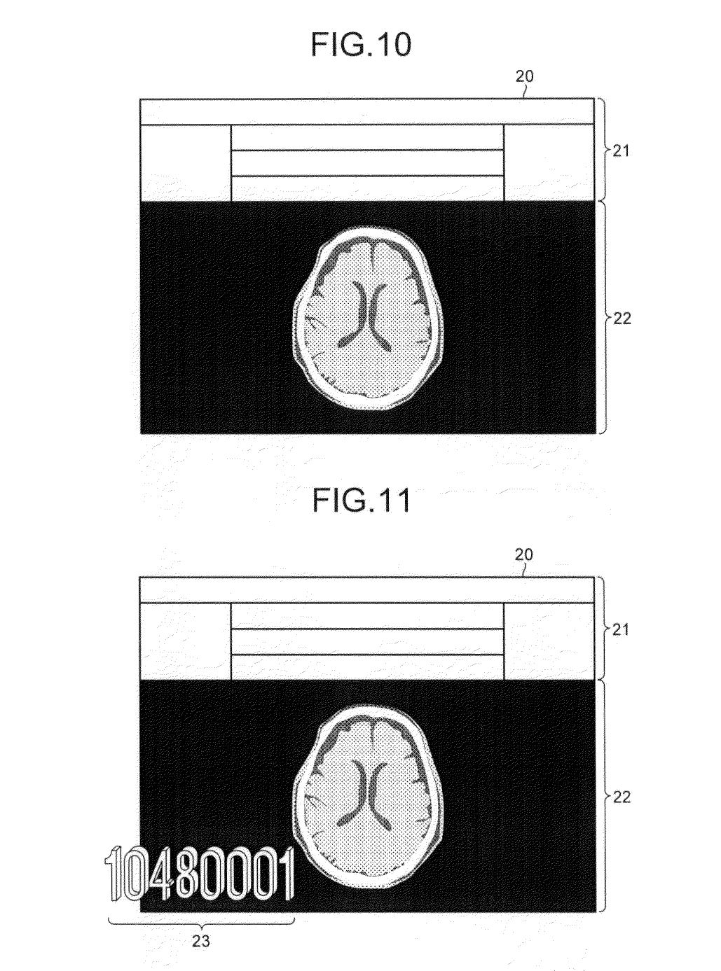

More specifically, the display controlling unit 125e causes the image viewer to be displayed on the display unit 123, in response to a request from the operator. FIG. 10 is a drawing of an example of the image viewer displayed by the display controlling unit 125e according to the present embodiment. As shown in FIG. 10, for example, an image viewer 20 includes: a specification input area 21 used by the operator for inputting a patient ID, an examination ID, or the like, to specify one or more medical images; and an image display area 22 used for displaying the one or more medical images specified by the operator. The example in FIG. 10 illustrates a situation where one medical image is displayed in the image display area 22; however, it is also possible to display two or more medical images side by side in the image display area 22.

In this situation, the display controlling unit 125e causes the image viewer to be displayed on the display unit 123 as a planar image. For example, if the display unit 123 is a stereoscopic display monitor that realizes a stereoscopic view by using nine-eye disparity images, the display controlling unit 125e assigns an equal pixel value to each of the nine columns of pixels 202 contained in mutually the same unit pixel group 203 illustrated in FIG. 3. As a result, the image viewer is displayed as a planar image on the display unit 123.

Further, when one or more medical images are specified by the operator while the image viewer is being displayed on the display unit 123, the display controlling unit 125e reads the image data of the one or more specified medical images from the image data storage unit 124a. After that, the display controlling unit 125e causes the image data read from the image data storage unit 124a to be displayed in the image viewer.

In this situation, in addition to causing the image data of the medical images to be displayed in the image viewer, the display controlling unit 125e also refers to the disparity image data storage unit 124e and reads the image data of the group of disparity images corresponding to the image data displayed in the image viewer. For example, the disparity image generating unit 125d reads the image data of the group of disparity images from the disparity image data storage unit 124e, on the basis of the image ID of the image data read from the image data storage unit 124a.

Further, the display controlling unit 125e causes the image data read from the disparity image data storage unit 124e to be displayed in the image viewer. In this situation, if the image data of the group of disparity images represents text data, the display controlling unit 125e causes the image data of the group of disparity images to be displayed in a predetermined position in the image viewer. For example, the display controlling unit 125e causes the image data of the group of disparity images to be displayed in a position in the image viewer where no medical image is displayed. As a result, a stereoscopic image of the text data is displayed in the image viewer, without hindering the operator from interpreting the medical images. In contrast, if the image data of the group of disparity images is image data representing the quantity of images, the display controlling unit 125e causes the image data of the group of disparity images to be displayed so as to overlap the medical images displayed in the image viewer. As a result, the operator is able to easily understand the quantity of medical images being displayed in the image viewer.

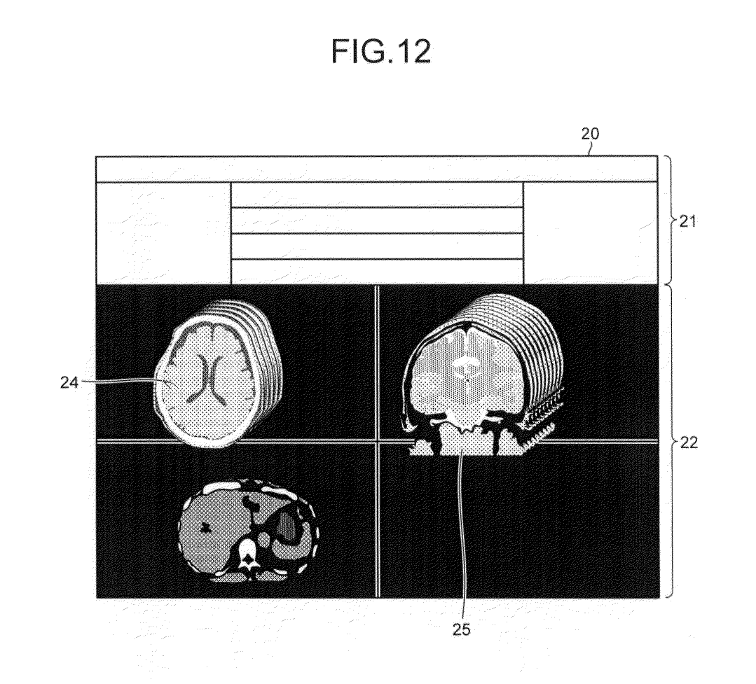

FIGS. 11 and 12 are examples of pieces of image data of groups of disparity images displayed in the image viewer by the display controlling unit 125e according to the present embodiment. For example, as shown in FIG. 11, the display controlling unit 125e causes image data 23 of a group of disparity images representing a patient ID “10480001” to be displayed in the image viewer 20, the patient ID corresponding to the image data displayed in the image display area 22. In another example, as shown in FIG. 12, the display controlling unit 125e causes pieces of image data 24 and 25 of groups of disparity images to be displayed so as to overlap the medical image being displayed in the image viewer 20, while varying the thicknesses of the groups of disparity images according to the quantities of images.

In this situation, for example, if the display unit 123 is a stereoscopic display monitor that realizes a stereoscopic view by using nine-eye disparity images, the display controlling unit 125e assigns pixel values of nine pixels that are in the same position in the nine disparity images to the nine columns of pixels 202 contained in mutually the same unit pixel group 203 illustrated in FIG. 3. As a result, as shown in FIGS. 11 and 12, either the text data or the image data representing the contents of the item contained in the additional information of the medical images is displayed in the image viewer 20 in such a manner that a stereoscopic view thereof is provided.

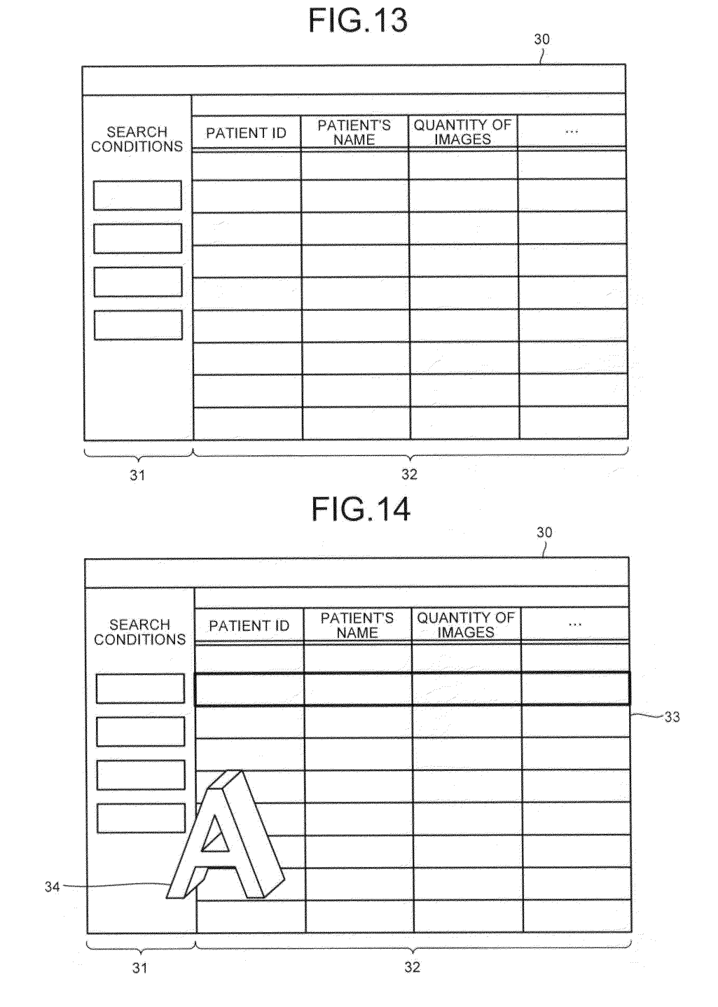

As another example, the display controlling unit 125e causes an examination list to be displayed on the display unit 123, in response to a request from the operator. FIG. 13 is a drawing of an example of the examination list displayed by the display controlling unit 125e according to the present embodiment. As shown in FIG. 13, for example, an examination list 30 includes: a search condition input area 31 used by the operator for inputting one or more search conditions such as a level of urgency when conducting a search in the examination information; and an examination information display area 32 used for displaying one or more pieces of examination information found in the search conducted by the operator in a list format.

In this situation, the display controlling unit 125e also causes the examination list to be displayed on the display unit 123 as a planar image, like the image viewer. For example, if the display unit 123 is a stereoscopic display monitor that realizes a stereoscopic view by using nine-eye disparity images, the display controlling unit 125e assigns an equal pixel value to each of the nine columns of pixels 202 contained in mutually the same unit pixel group 203 illustrated in FIG. 3, in the same manner as when the image viewer is displayed. As a result, the examination list is displayed as a planar image on the display unit 123.

Further, when one or more search conditions are received from the operator while the examination list is being displayed on the display unit 123, the display controlling unit 125e refers to the examination information storage unit 124b, searches for examination information that matches the received search conditions, and displays one or more pieces of examination information found in the search in the examination list.

After that, when the operator has selected a piece of examination information out of the examination list, the display controlling unit 125e reads the image data of the group of disparity images corresponding to the selected piece of examination information from the disparity image data storage unit 124e. For example, the display controlling unit 125e reads the image data of the group of disparity images from the disparity image data storage unit 124e, on the basis of the examination ID of the examination information read from the examination information storage unit 124b.

After that, the display controlling unit 125e causes the image data read from the disparity image data storage unit 124e to be displayed over the examination list. In this situation, the display controlling unit 125e causes the image data of the group of disparity images to be displayed in a predetermined position over the examination list. For example, the display controlling unit 125e causes the image data of the group of disparity images to be displayed so as not to overlap the selected piece of examination information. As a result, a stereoscopic image of the text data is displayed over the examination list without hindering the operator from checking the examination information.

FIG. 14 is a drawing of an example of image data of a group of disparity images displayed over an examination list by the display controlling unit 125e according to the present embodiment. For example, as shown in FIG. 14, the display controlling unit 125e causes image data 34 of a group of disparity images representing a level of urgency “A” to be displayed over the examination list 30, the level of urgency corresponding to examination information 33 having been selected out of the examination list 30.

In this situation, for example, if the display unit 123 is a stereoscopic display monitor that realizes a stereoscopic view by using nine-eye disparity images, the display controlling unit 125e assigns pixel values of nine pixels that are in the same position in the nine disparity images to the nine columns of pixels 202 contained in mutually the same unit pixel group 203 illustrated in FIG. 3. As a result, as shown in FIG. 14, the text data representing the contents of the item contained in the examination information is displayed over the examination list 30 in such a manner that a stereoscopic view thereof is provided.

In the examples illustrated in FIGS. 11, 12, and 14, the pieces of image data 23 to 25 and 34 are illustrated in perspective views, in order to conceptually express the manner in which the pieces of image data of the groups of disparity images are displayed on the stereoscopic display monitor. However, in actuality, image data of disparity images is not necessarily displayed as illustrated in the drawings when being displayed on a stereoscopic display monitor. How the image data appears may vary depending on the type of the stereoscopic display monitor being used.

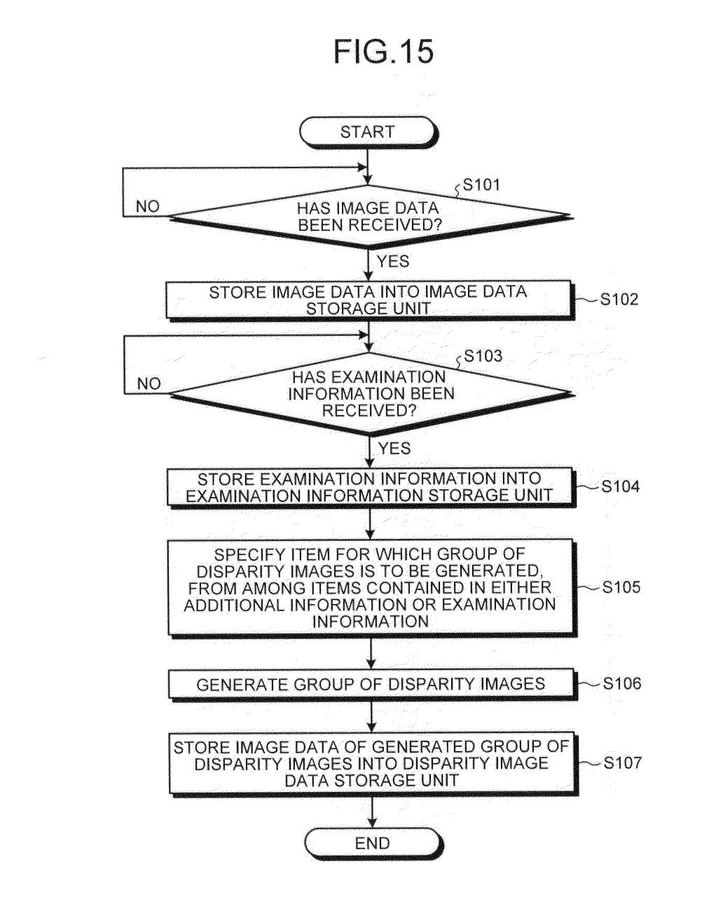

Next, procedures in image processing processes performed by the medical image storing apparatus 120 according to the present embodiment will be explained. FIGS. 15 to 17 are flowcharts of the procedures in the image processing processes performed by the medical image storing apparatus 120 according to the present embodiment.

First, processes performed by the image data receiving unit 125a, the examination information receiving unit 125b, the importance level judging unit 125c, and the disparity image generating unit 125d will be explained, with reference to FIG. 15. As shown in FIG. 15, in the medical image storing apparatus 120 according to the present embodiment, when the image data receiving unit 125a has received image data of medical images sent from any of the medical image taking apparatuses 110 (step S101: Yes), the received image data and additional information are stored into the image data storage unit 124a while being kept in correspondence with each other (step S102).

Further, when the examination information receiving unit 125b has received examination information sent from the medical image taking apparatus 110 (step S103: Yes), the received examination information and the image data of the medical images related to the examination information are stored into the examination information storage unit 124b while being kept in correspondence with each other (step S104).

After that, on the basis of the levels of importance stored in the importance level storage unit 124c, the importance level judging unit 125c specifies an item for which a group of disparity images is to be generated, from among the items contained in either the additional information or the examination information of the medical images (step S105).

Subsequently, the disparity image generating unit 125d generates a group of disparity images used for displaying either text data or image data representing the contents of the item contained in either the additional information or the examination information of the medical images, in such a manner that a stereoscopic view thereof is provided (step S106). After that, the disparity image generating unit 125d stores image data of the generated group of disparity images into the disparity image data storage unit 124e (step S107).

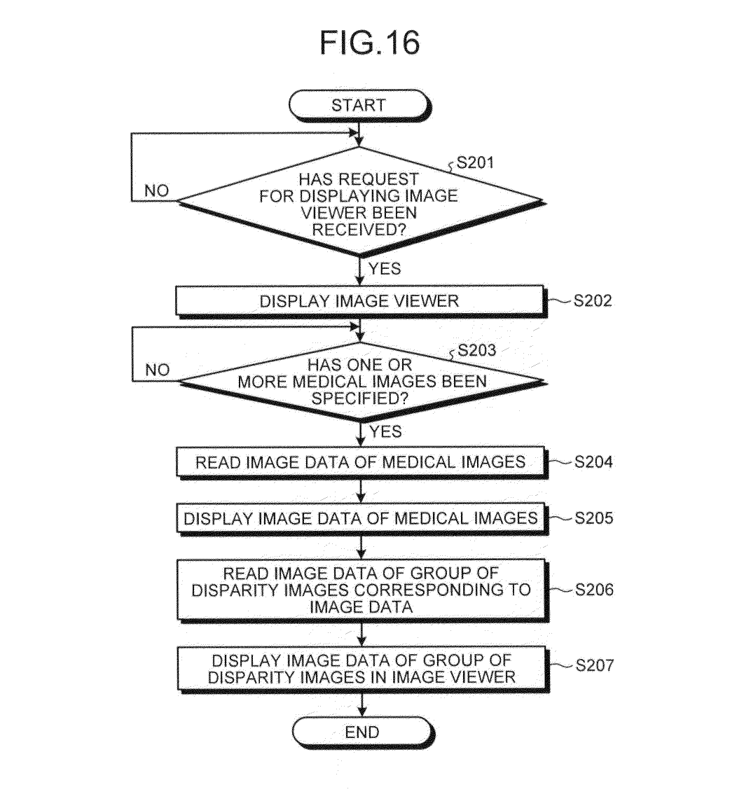

Next, a process related to displaying of the image viewer performed by the display controlling unit 125e will be explained, with reference to FIG. 16. As shown in FIG. 16, in the medical image storing apparatus 120 according to the present embodiment, when having received a request from the operator indicating that an image viewer should be displayed (step S201: Yes), the display controlling unit 125e causes the image viewer to be displayed on the display unit 123 (step S202).

After that, when the operator has specified one or more medical images while the image viewer is being displayed on the display unit 123 (step S203: Yes), the display controlling unit 125e reads the image data of the specified medical images from the image data storage unit 124a (step S204). After that, the display controlling unit 125e causes the read image data of the medical images to be displayed in the image viewer (step S205).

Further, the display controlling unit 125e refers to the disparity image data storage unit 124e and reads image data of a group of disparity images corresponding to the image data displayed in the image viewer, from the disparity image data storage unit 124e (step S206). After that, the display controlling unit 125e causes the read image data of the group of disparity images to be displayed in the image viewer (step S207).

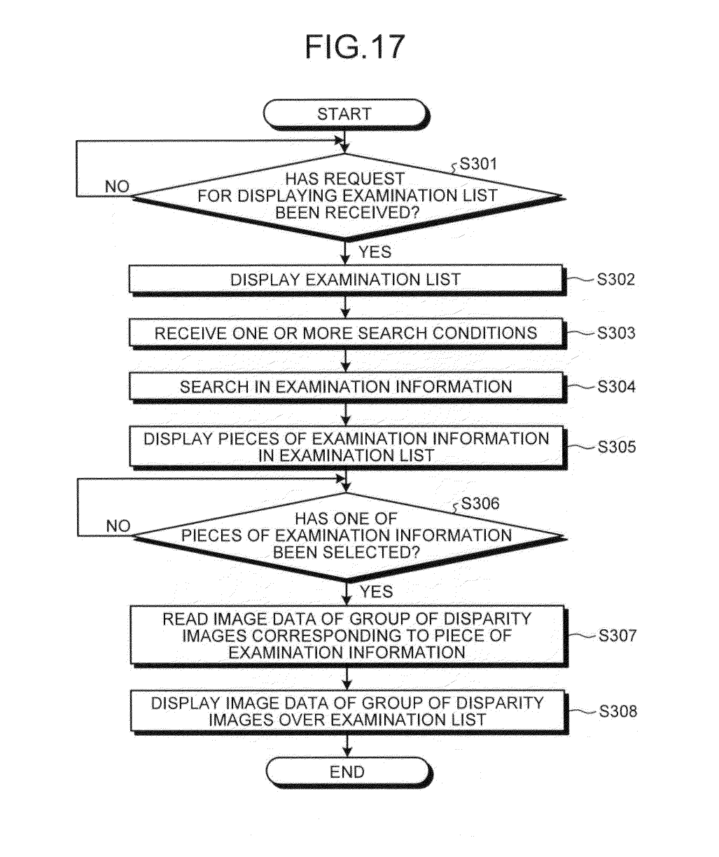

Next, a process related to the displaying of the examination list performed by the display controlling unit 125e will be explained, with reference to FIG. 17. As shown in FIG. 17, in the medical image storing apparatus 120 according to the present embodiment, when having received a request from the operator indicating that an examination list should be displayed (step S301: Yes), the display controlling unit 125e causes the examination list to be displayed on the display unit 123 (step S302).

After that, when one or more search conditions are received from the operator while the examination list is being displayed on the display unit 123 (step S303), the display controlling unit 125e refers to the examination information storage unit 124b and searches for pieces of examination information that match the received search conditions (step S304). After that, the display controlling unit 125e causes pieces of examination information found in the search to be displayed in the examination list (step S305).

Subsequently, when the operator has selected one of the pieces of examination information out of the examination list (step S306: Yes), the display controlling unit 125e reads image data of a group of disparity images corresponding to the selected piece of examination information from the disparity image data storage unit 124e (step S307). After that, the display controlling unit 125e causes the read image data of the group of disparity images to be displayed over the examination list (step S308).

As explained above, according to the present embodiment, the medical image storing apparatus 120 is configured to cause either the text data or the image data representing the contents of the item contained in either the additional information or the examination information of the medical images to be displayed, in such a manner that a stereoscopic view thereof is provided, on the stereoscopic display monitor capable of displaying stereoscopic images. It is therefore possible to display the information that is referred to during an image interpretation process or an examination process, while emphasizing the information. Consequently, because the contents of the item in the additional information or the examination information are displayed while being emphasized when the medical images are interpreted or when the examination information is checked, it is possible to prevent these types of information from being overlooked.

The one exemplary embodiment has thus been explained; however, possible embodiments of the medical image processing system are not limited to the exemplary embodiment.

For example, in the embodiment described above, the example is explained in which the importance level judging unit 125c specifies the item having the highest level of importance among the items contained in either the additional information or the examination information, as the item for which the group of disparity images is to be generated. In another embodiment, it is acceptable to configure the importance level judging unit 125c so as to, for example, specify a plurality of items as the items for which groups of disparity images are to be generated, in descending order of the levels of importance while starting with the highest level among the items contained in either the additional information or the examination information. For example, the importance level judging unit 125c may specify three items as the items for which the groups of disparity images are to be generated, in descending order of the levels of importance while starting with the highest level. In that situation, the disparity image generating unit 125d generates the groups of disparity images for the plurality of items. After that, the display controlling unit 125e causes the display unit 123 to simultaneously display the plurality of groups of disparity images generated by the disparity image generating unit 125d.

In yet another example, it is acceptable to configure the importance level judging unit 125c so as to, for example, specify one or more items having a level of importance higher than a predetermined threshold value as items for which groups of disparity images are to be generated, from among the items contained in either the additional information or the examination information. For example, when the levels of importance “1” to “5” are stored in the importance level storage unit 124c, the importance level judging unit 125c may use “2” as a threshold value. Further, the importance level judging unit 125c may specify one or more items of which the level of importance is “2” or higher as the items for which groups of disparity images are to be generated. In this situation, the disparity image generating unit 125d generates a group of disparity images for each of the one or more items specified by the importance level judging unit 125c. After that, the display controlling unit 125e causes the display unit 123 to simultaneously display the one or more groups of disparity images generated by the disparity image generating unit 125d.

In the embodiment described above, functions of the medical image storing apparatus 120 are explained, for example; however, the same functions may be provided in one or more selected from the medical image taking apparatuses 110, the medical image display apparatus 130, and the report generation supporting apparatus 140. In that situation, one or more apparatuses are provided with a display unit capable of displaying a stereoscopic image. Further, for example, by using image data generated thereby or examination information received thereby, each of the medical image taking apparatuses 110 performs the same processes as those performed by the medical image storing apparatus 120 explained in the embodiment above. Further, for example, the medical image display apparatus 130 and the report generation supporting apparatus 140 obtain the image data from the medical image storing apparatus 120 and obtain the examination information from any of the medical image taking apparatuses 110 so as to perform the same processes as those performed by the medical image storing apparatus 120 explained in the embodiment above.

Further, for example, in the embodiment described above, the example is explained in which the medical image storing apparatus 120 is configured to include all the functional units illustrated in FIG. 2; however, these functional units may be provided as being distributed in a plurality of apparatuses. In that situation, for example, one or more selected from the medical image taking apparatuses 110, the medical image display apparatus 130, and the report generation supporting apparatus 140 are provided with a display unit capable of displaying a stereoscopic image and a display controlling unit. Further, for example, when displaying image data generated thereby or examination information received thereby, each of the medical image taking apparatuses 110 obtains image data of a group of disparity images corresponding to either the displayed image data or the displayed examination information from the medical image storing apparatus 120 and causes the obtained image data to be displayed on the display unit. Further, for example, the medical image display apparatus 130 and the report generation supporting apparatus 140 obtain the image data from the medical image storing apparatus 120, obtain the examination information from any of the medical image taking apparatuses 110, and further obtain the image data of the group of disparity images corresponding to either the obtained image data or the obtained examination information from the medical image storing apparatus 120, so as to cause the obtained image data to be displayed on the display unit.

In another example, the functions of the controlling unit 125 explained in the embodiment above may be realized by using software. For example, the functions of the controlling unit 125 may be realized by causing a computer to execute a medical image processing computer program that defines the procedure in the processes explained as being performed by the controlling unit 125 in the embodiment above. The medical image processing computer program is, for example stored in a hard disk or a semiconductor memory element and is read and executed by a processor such as a Central Processing Unit (CPU) or a Micro Processing Unit (MPU). Also, the medical image processing computer program can be distributed as being recorded on a computer-readable recording medium such as a Compact Disc Read-Only Memory (CD-ROM), a Magneto Optical Disc (MO), or a Digital Versatile Disc (DVD).

Further, for example, in the embodiment described above, the example is explained in which the disparity image generating unit 125d generates the disparity images by performing the volume rendering process; however, possible embodiments are not limited to this example. For example, the disparity image generating unit 125d may generate the disparity images by implementing other rending methods such as a surface rendering method and a global illumination method. In this situation, the volume rendering process uses the method by which two-dimensional images that reflect three-dimensional information are generated directly from volume data. In contrast, the surface rendering process uses a method by which a model is constructed by extracting targeted data from volume data so that two-dimensional images that reflect three-dimensional information are generated on the basis of the constructed model. The global illumination process uses a method by which it is possible to obtain more realistic two-dimensional images by rendering volume data while taking propagation of light (attenuations, reflections, etc.) in the real world into consideration.

Further, for example, in the embodiment described above, the example is explained in which the display unit 123 is a stereoscopic monitor capable of displaying the stereoscopic image by displaying the group of disparity images, whereas the disparity image generating unit generates, as the display image to be displayed on the display unit, the group of disparity images used for displaying either the text data or the image data representing the contents of the item contained in either the additional information or the examination information of the medical images in such a manner that a stereoscopic view thereof is provided. However, possible embodiments are not limited to this example.

For example, the display unit may be a planar display monitor capable of displaying a planar image, so that a planar image stereoscopically expressing either the text data or the image data is displayed on the display unit. In that situation, a generating unit configured to generate planar images generates, as the planar image, a two-dimensional image obtained by performing a volume rendering process from one line-of-sight direction on the volume data of either the text data or the image data. In that situation also, it is possible to use other rendering methods such as the surface rendering method or the global illumination method.

According to at least one aspect of the embodiments explained above, it is possible to display the information that is referred to during the image interpretation process or the examination process, while emphasizing the information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image processing system comprising:
a display unit configured to display a medical image;
a generating unit configured to generate a display image used for stereoscopically displaying either text data or image data representing content of an item contained in either additional information or examination information of the medical image; and
a display controlling unit configured to cause the display image to be displayed on the display unit.

2. The medical image processing system according to claim 1 further comprising:
an importance level storage unit configured to store therein a level of importance for each of a plurality of items contained in either the additional information or the examination information; and
an importance level judging unit configured to specify the one of the items for which the display image is to be generated, from among the items contained in either the additional information or the examination information, on a basis of the levels of importance, wherein
the generating unit generates the display image for the specified item.

3. The medical image processing system according to claim 1, wherein
the generating unit generates the display image for the item that is used when the medical image is interpreted, and
the display controlling unit causes the display image to be displayed in the image viewer, while an image viewer used for displaying the one or more medical images in response to a request from an operator is being displayed on the display unit.

4. The medical image processing system according to claim 1, wherein
the generating unit generates the display image for the item that is used when the examination information is searched, and
the display controlling unit causes the display image to be displayed over the examination list, while an examination list used for conducting searches in the examination information in response to a request from an operator is being displayed on the display unit.

5. The medical image processing system according to claim 1, wherein, when the item is a quantity of medical images, the generating unit generates the display image used for stereoscopically displaying the image data of which a thickness is varied according to a value of the quantity of images.

6. The medical image processing system according to claim 1, wherein
the display unit is capable of displaying a stereoscopic image by displaying a group of disparity images, and
the generating unit generates a group of disparity images used for displaying either the text data or the image data in such a manner that a stereoscopic view thereof is provided, as the display image.

7. The medical image processing system according to claim 1, wherein the generating unit generates a planar image stereoscopically expressing either the text data or the image data, as the display image.

8. A medical image processing method comprising:
generating a display image used for stereoscopically displaying either text data or image data representing content of an item contained in either additional information or examination information of a medical image; and
causing the display image to be displayed on a display unit.

9. A non-transitory computer-readable medium storing instructions executable by a computer, wherein the instructions cause the computer to perform:
generating a display image used for stereoscopically displaying either text data or image data representing content of an item contained in either additional information or examination information of a medical image; and
causing the display image to be displayed on a display unit.
